(19) United States
(12) Patent Application Publication
(10) Pub. No.: US 2006/0052078 A1
(43) Pub. Date: Mar. 9, 2006

(54) Device for amplifying the signal from a receive antenna

(75) Inventor: Jean-Claude Ducasse, Taluyers (FR)

Correspondence Address: OLIFF & BERRIDGE, PLC, P.O. BOX 19928, ALEXANDRIA, VA, 22320, US

(73) Assignee: MMDS HYPERCABLE, Taluyers (FR)

(21) Appl. No.: 11/058,228

(22) Filed: Feb. 16, 2005

(30) Foreign Application Priority Data
Sep. 7, 2004 (FR) 04.09453

(51) Int. Cl. H04B 1/16; H04B 1/10

(52) U.S. Cl. 455/341; 455/334

(57) ABSTRACT

Device for amplifying the signal from a receive antenna Device for amplifying the signal from an antenna for receiving waves in a first frequency band, in particular of radiofrequency type, comprising signal amplification means and means of converting the signal from a first frequency band to a second, lower frequency band. The device also comprises means of controlling the amplification means taking as the input signal a signal derived from the output signal of the amplification device.

### BACKGROUND OF THE INVENTION

The present invention relates to a device for amplifying the output signal of an antenna for an installation receiving waves, in particular radiofrequency waves, sent by a terrestrial transmitter.

Radiofrequency waves can be used to transmit large quantities of analog or digital data, so enabling applications such as television or high speed Internet access.

These waves are subject, between their transmission by a transmitter and their reception by the receiver, to an attenuation due to the distance covered and their passage through the atmosphere and need to be amplified, after reception by an antenna, by an amplification device, for example by a low noise feed block, called LNA or LNB, before being processed by a device at the output of the amplification device such as a decoder, which normally presents a limited bandwidth in terms of power between the high and low limits.

Furthermore, for good reception, the antenna must be pointing in the direction of the transmitter.

Transmission of these waves via a satellite has long been known.

In this case, the satellite, considered as the transmitter, is located in orbit around the Earth and the receivers are located on the ground.

The attenuation due to the atmosphere is very comparable between two receiving antennas located on the surface of the Earth at two locations a few hundred kilometers apart. In practice, the length of atmosphere crossed is substantially equal to the thickness of the atmosphere.

Consequently, the amplification needed to enable the signal to be located within the bandwidth of the decoder is also comparable between the different reception points.

Moreover, the antenna can be pointed in a comparable way at the different reception points, since the angles of inclination for pointing the antenna towards the satellite do not vary significantly between two points a few hundred kilometers apart on the surface of the Earth.

For radiofrequency waves transmitted from terrestrial transmitters, however, the signal attenuation incurred between the transmitter and the receiver does vary very significantly between two reception points.

In practice, the length of atmosphere crossed is variable and roughly corresponds to the geographical distance separating the transmitter from the receiver.

Also, a multiplicity of transmitters must be positioned to be able to cover a significant geographical area, since the waves cannot in practical terms exceed a distance of the order of a few tens of kilometers, given the roundness of the Earth and the attenuation due to the atmosphere and of the distance covered. This means the antenna must be pointed specifically at each reception point, because:
different transmitters are used,
for the same transmitter, the pointing angles vary widely between two reception points.

The reception of terrestrial radiofrequency waves therefore raises two specific technical problems:
the amplification device needs to be able to apply a variable gain to the input signal, dependent on the reception point, and
the pointing of the receive antenna towards a transmitter must take into account the relative position of a given reception point in relation to a multiplicity of transmitters.

### DESCRIPTION OF THE PRIOR ART

The first problem can be resolved using a variable gain device, the gain of which is determined on installing the receiving device. However, this solution complicates installation, because a signal measurement is necessary, and installation needs to be carried out by a qualified person. Also, the gain cannot be adjusted subsequently, according to the climatic conditions or the signal strength level of a specific carrier signal to which the decoder is tuned.

An automatic gain adjustment solution has also been proposed, involving producing an assembly, in which one or more amplifiers are arranged upstream from the decoder, a variable number of these amplifiers being able to be used at any time, under the control of the decoder positioned downstream on the line which returns information over the line, to indicate whether the signal strength level at its input is indeed between its acceptable upper and lower limits.

This type of device handles gain control taking into account the signal strength level at the decoder.

The decoder may be separate from the amplification device, by length of cable possibly being particularly long, and the cable may be of poor quality. For example, the antenna is located on the roof of a building, with an amplification device, and the decoder is located several floors below.

In these conditions, the attenuation due to the cable is very high, and the information transmitted in return controlling the amplification is distorted. In practice, this information does not estimate the signal strength level at the output of the amplifier, the role of which is to offset the attenuation caused by the passage through the atmosphere, but the strength level at the input of the decoder, taking into account the attenuation due to the cable.

Consequently, the amplifier can be set, for example, to an excessively high value by the decoder, so resulting in saturation of the intermediate signal and a poor quality signal.

To resolve the second problem of pointing of the antenna, the latter must be installed using a signal strength level measuring device, this type of device being expensive and therefore requiring the presence of a technician on installing the antenna.

In practice, the antenna is often arranged on the roof of a building, and it is therefore difficult to use, for example, the quality of a picture received on a reception device connected to the decoder to assess the pointing of the antenna relative to the transmitter. It is therefore necessary to use a dedicated wave analyzer type device.

### SUMMARY OF THE INVENTION

The object of the present invention is to provide a reception device on the one hand enabling an improved signal quality to be obtained regardless of the quality of the link cable between the decoder and the reception device, and on the other hand simplifying the installation of the device, and in particular the pointing of the receive antenna.

To this end, the object of the present invention is to produce a device for amplifying the signal from an antenna for receiving waves in a first frequency band, in particular of radiofrequency type, comprising:
signal amplification means, and
means of converting the signal from a first frequency band to a second, lower frequency band,
   which comprises means of controlling the amplification means taking as the input signal a signal derived from the output signal of the amplification device.

This arrangement makes it possible to control the amplification of the signal without taking into account the attenuation due to a connecting cable to a decoder, and so to produce control of the amplification at the level of the amplification device.

Advantageously, the device comprises signal amplification means, comprising at least one constant gain amplifier, linked in series to at least one attenuator, the variable attenuation of which is controlled by the control means.

This arrangement makes it possible to avoid the use of controlled amplification devices or controlled gain amplifiers of the AGC type, which impart phase noises incompatible with digital modulation.

According to an embodiment, the device comprises means of informing a user linked to the control means, providing the user with information on the signal strength level processed by the control means.

Advantageously, the information means comprise a visual indicator of the signal strength level.

According to an embodiment, the visual indicator comprises a strip of light-emitting diodes, with the number of diodes on or off being indicative of the signal strength level.

Advantageously, the amplification means comprise first means of amplifying the signal in the first frequency band, comprising at least one constant gain amplifier, linked in series to at least one attenuator, the variable attenuation of which is controlled by the control means.

According to an embodiment, the amplification means comprise second means of amplifying the signal in a second frequency band.

Advantageously, the amplification means are associated with filtering means.

According to an embodiment, the device also comprises means of selecting the polarization plane in which reception must be performed, from a signal originating from the output line, in particular from a decoder.

Advantageously, the first signal amplification means comprise at least two amplifiers connected in parallel designed to amplify the signal received from the antenna in at least two polarization planes.

According to an embodiment, the first amplification means comprise two attenuators in series, between which is positioned an amplifier.

Advantageously, the means of converting the signal to a second, lower frequency band comprise at least one local oscillator and a mixer combining the signal from this oscillator with the output signal from the first amplification means.

According to an embodiment, the conversion means comprise at least two local oscillators used to generate at least two different output frequencies in the selected polarization plane.

Advantageously, the second amplification means comprise at least one fixed gain amplifier.

According to an embodiment, the input signal of the control means is obtained using a coupler from the output signal of the device.

Advantageously, the coupler is linked in series to a capacitor type high-pass component, then to an amplifier, then to the controller.

According to an embodiment, the coupler comprises a module passed through by the output line and a section of conductive wire grounded through a resistor.

Advantageously, the control means comprise a circuit for adjusting the variable attenuation of the attenuators according to the signal strength level at the output of the device to obtain an output signal, the strength level of which is between defined upper and lower limits.

### DESCRIPTION OF THE DRAWINGS

However, the invention will be better understood from the description that follows, with reference to the appended schematic diagram, representing, by way of non-limiting example, an embodiment of the device according to the invention.

FIG. 1 is a representation of an antenna with an amplification device as claimed in the invention, and a decoder, linked by a cable to the amplification device.

FIG. 2 is a diagrammatic representation of the electrical circuit of the device.

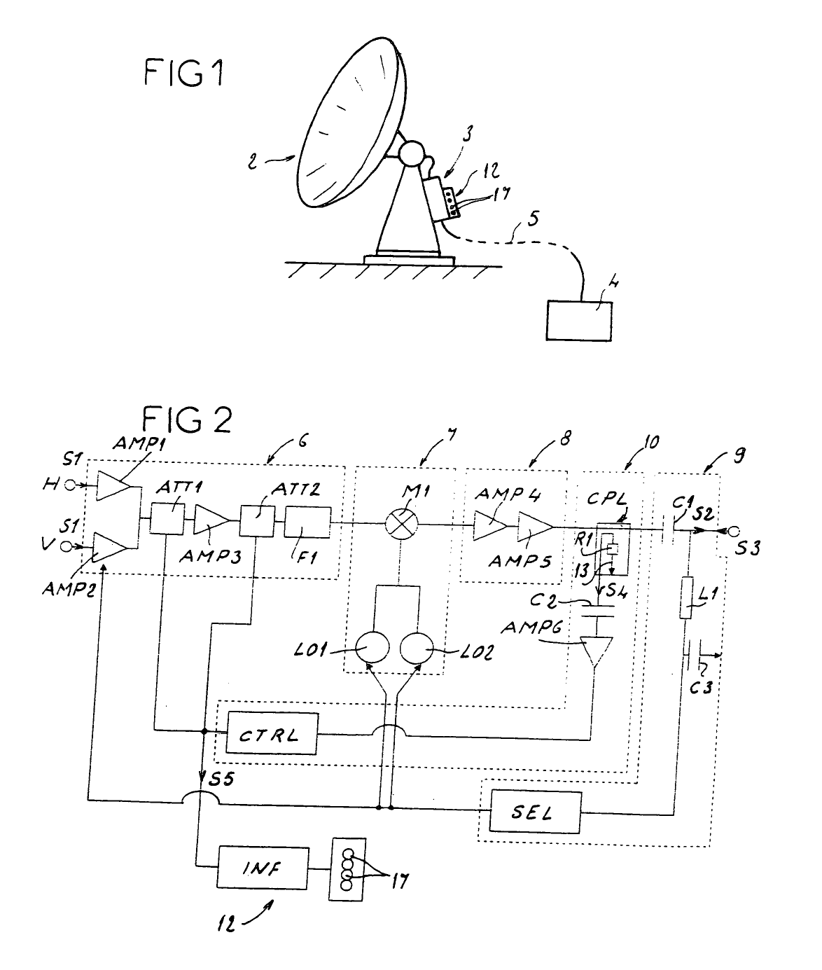

### DESCRIPTION OF THE PREFERRED EMBODIMENTS

In a known way, an installation receiving a radiofrequency, or RF, signal sent by a satellite or a terrestrial transmitter, comprises:
a receive antenna 2, to be pointed in the direction of a transmitter, not shown,
an amplification device, of the low noise feed block type 3, also called LNB, designed to amplify the output signal S of the antenna and produce an output signal S2 in an intermediate frequency, or IF, band, and
a decoder 4, designed to decode the signal to supply it to customer devices such as a television or a computer.

The feed block 3 is positioned near the antenna 2, the decoder is linked to the amplification device via a cable 5, the length of which can extend to several tens of meters.

In the embodiment represented, the radiofrequency signal can be transmitted in two different polarization planes, named V and H.

The signal S1, in the case of a V polarization, comprises frequencies between 10.7 and 11.7 GHz.

The signal S1, in the case of an H polarization, comprises frequencies between 11.7 and 12.7 GHz.

A device 3 for amplifying the signal from an antenna 2 receiving radiofrequency waves according to the invention, comprises:
first means 6 of amplifying the radiofrequency signal S1,
means 7 of converting the radiofrequency signal to a frequency band below radiofrequency, called intermediate frequency,
second means 8 of amplifying the intermediate frequency signal,
means 9 of selecting the polarization plane in which reception must be performed, from the output line.

According to an essential characteristic of the invention, the amplification device also comprises means 10 of controlling the amplification means 6, taking as input the output signal S2 of the amplification device, and comparing this signal to at least one reference value.

The signal S2, in the case of a V polarization, comprises frequencies between 950 and 1950 MHz.

The signal S2, in the case of an H polarization, comprises frequencies between 1100 and 2150 MHz.

The first means 6 of amplifying the radiofrequency signal comprise:
two constant gain amplifiers AMP1 and AMP2 mounted in parallel and respectively designed to amplify the antenna signal S1 in both H and V polarization planes of the signal received by the antenna, then, in series with the two amplifiers,
a first attenuator ATT1, the variable attenuation of which is controlled by the control means 10,
a third constant gain amplifier AMP3,
a second attenuator ATT1, the variable attenuation of which is controlled by the control means 10, and
a filter F used in particular to reduce the signal noise.

The means 7 of converting the radiofrequency signal to an intermediate frequency, comprise:
two local oscillators LO1 and LO2, in parallel, for respectively generating a signal at 9.75 and 10.6 GHz and a mixer MI combining the output signal of these oscillators with the output signal of the first means 7 of amplifying the radiofrequency signal, the mixing being used to obtain a signal in the intermediate frequency range.

The second intermediate frequency signal amplification means comprise two fixed gain amplifiers AMP4 and AMP5.

The polarization selection means 9 are used to activate selectively the local oscillators LO1 and LO2 and the amplifiers AMP1 or AMP2, in the H or V polarization plane, according to a low frequency signal originating from the output of the device, from the decoder 4.

These means comprise:
a capacitor C1 forming a high-pass filter located at the output of the intermediate frequency signal amplification means for isolating the means of amplifying and converting the selection signal from the decoder,
an inductance L1 situated on a shunt line from the output line, associated with a second capacitor C3 linked to ground, forming a low-pass filter for isolating the means of selecting the intermediate frequency signal S2 produced on the output line but allowing the selection signal S3 from the decoder to pass,
a selector SEL using the selection signal S3, based on the values taken by this signal, to activate the local oscillator LO1 and the amplifiers AMP1, when the polarization plane of the carrier to which the decoder is tuned is in the H polarization plane, and to activate the local oscillator LO2 and the amplifier AMP2, when the polarization plane of the carrier to which the decoder is tuned is in the V polarization plane.

The control means 10 comprise, linked in series:
a coupler CPL for generating a signal S4 obtained by magnetic coupling from the intermediate frequency signal S2,
a capacitor C2 forming a high-pass filter, then
an amplifier AMP6 for amplifying the signal S4, and
a controller CTRL.

The controller CTRL comprises an electronic circuit comparing the strength level of the signal S4 with predefined signal strength levels to determine the control to be applied to the variable attenuation of the two attenuators ATT1 and ATT2.

The control means 10 are thus used to adjust the variable attenuation of the attenuators ATT1, ATT2 according to the signal strength level at the output of the device to obtain an output signal S2, the strength level of which is between defined upper and lower limits.

The coupler CPL comprises a module 12 surrounding the output line in which the signal S2 circulates, and an additional conductor positioned close to the latter to provide magnetic coupling, the first end of the conductor being linked to a resistor R1 and to the module 12 via a ground wire 13, the other end of the conductor exiting from the module and forming the output of the coupler CPL.

The amplification device 3 further comprises means 14 of informing a user, to help the latter point the antenna 2 relative to the transmitter.

The information means 14 comprise:
a comparison component INF which is linked to the controller,
a visual indicator 17 consisting of a strip of light-emitting diodes or LEDs.

The comparison component compares the strength level of the signal received from the controller CTRL with predefined values, and orders the lighting of one or more LEDs according to the observed signal strength level.

Thus, the user can adjust the orientation of the antenna until all the LEDs are lit, indicating good quality reception.

Obviously, the invention is not limited to the preferred embodiment described above, by way of non-limiting example; on the contrary, it encompasses all the variants within the scope of the following claims.

1. A device for amplifying the signal from an antenna for receiving waves in a first frequency band, in particular of radiofrequency type, comprising:
signal amplification means, and
means of converting the signal from a first frequency band to a second, lower frequency band,
which comprises means of controlling the amplification means taking as the input signal a signal derived from the output signal of the amplification device.

2. The device as claimed in claim 1, which comprises signal amplification means, comprising at least one constant gain amplifier, linked in series to at least one attenuator, the variable attenuation of which is controlled by the control means.

3. The device as claimed in claim 1, wherein means of informing a user are linked to the control means, providing a user with information on the signal strength level processed by the control means.

4. The device as claimed in claim 3, wherein the information means comprise a visual indicator of the signal strength level.

5. The device as claimed in claim 4, wherein the visual indicator comprises a strip of light-emitting diodes, with the number of diodes on or off being indicative of the signal strength level.

6. The device as claimed in one claim 1, wherein the amplification means comprise first means of amplifying the signal in the first frequency band, comprising at least one constant gain amplifier, linked in series to at least one attenuator, the variable attenuation of which is controlled by the control means.

7. The device as claimed in claim 1, wherein the amplification means comprise second means of amplifying the signal in a second frequency band.

8. The device as claimed in claim 1, wherein the amplification means are associated with filtering means.

9. The device as claimed in claim 1, which also comprises means of selecting the polarization plane in which reception must be performed, from a signal originating from the output line, in particular from a decoder.

10. The device as claimed in claim 1, wherein the first signal amplification means comprise at least two amplifiers connected in parallel designed to amplify the signal received from the antenna in at least two polarization planes.

11. The device as claimed in claim 1, wherein the first amplification means comprise two attenuators in series, between which is positioned an amplifier.

12. The device as claimed in claim 1, wherein the means of converting the signal to a second, lower frequency band comprise at least one local oscillator and a mixer combining the signal from this oscillator with the output signal from the first amplification means.

13. The device as claimed in claim 12, wherein the conversion means comprise at least two local oscillators used to generate at least two different output frequencies in the selected polarization plane.

14. The device as claimed in claim 7, wherein the second amplification means comprise at least one fixed gain amplifier.

15. The device as claimed in claim 1, wherein the input signal of the control means is obtained using a coupler from the output signal of the device.

16. The device as claimed in claim 1, wherein the coupler is linked in series to a capacitor type high-pass component, then to an amplifier, then to the controller.

17. The device as claimed in claim 1, wherein the coupler comprises a module passed through by the output line and a section of conductive wire grounded through a resistor.

18. The device as claimed in claim 2, wherein the control means comprise a circuit for adjusting the variable attenuation of the attenuators according to the signal strength level at the output of the device to obtain an output signal, the strength level of which is between defined upper and lower limits.
